(19) United States
(12) Patent Application Publication
(10) Pub. No.: US 2024/0303578 A1
(43) Pub. Date: Sep. 12, 2024

(54) OPERATING END EXPORT OPERATIOIN SYSTEM FOR LOGISTICS

(71) Applicants: Zhen-sheng Wang, SANTA FE SPRINGS, CA (US); Ze-Nong Wang, SANTA FE SPRINGS, CA (US); Ze-Feng Wang, SANTA FE SPRINGS, CA (US)

(72) Inventors: Zhen-sheng Wang, SANTA FE SPRINGS, CA (US); Ze-Nong Wang, SANTA FE SPRINGS, CA (US); Ze-Feng Wang, SANTA FE SPRINGS, CA (US)

(21) Appl. No.: 18/118,693

(22) Filed: Mar. 7, 2023

(51) Int. Cl. G06Q 10/083

(52) U.S. Cl. CPC G06Q 10/083

(57) ABSTRACT

An operating end export operation system for logistics includes transmission linked an order module, a booking operation module, a transmission module, a processing module, a display module, and a recording module. The operating end export operation system communicates with a client end communication tool, a shipping company booking system and a shipping end communication tool. The booking operation module receives the multiple orders with product information, and transmits the product information of each order to the shipping company booking system for booking. After completing the booking, the shipping company booking system transmits a booking information containing the customs requirement to the transmission module which then transmits the booking information to the processing module, the recording module and the shipping end communication tool. The processing module receives the booking information and sends a dispatch order for pickup to the display module. The recording module records the contents of each order.

### BACKGROUND OF THE INVENTION

### 1. Fields of the invention

The present invention relates to a shipping client export operation system for logistics, specifically designed to effectively coordinate with the client end communication tool and the operating end export operation system, to quickly query the progress of each order, thus realizing the full visualization of online service for ordering, booking, and truck dispatch.

### 2. Descriptions of Related Art

The conventional international cargo export operation process comprises the following steps which are that after receiving the order from a client, according to the name, weight, volume and other conditions of the goods, and the requirements of the shipping company and customs, the shipping information is sent to the shipping company through paper, mail, telephone, SMS, etc. to complete the booking. The shipping company then returns the booking information back to the cargo company by means of paper, mail, telephone, SMS, etc. The cargo company conveys the booking information to customers by paper, mail, phone, text messages, etc., and requests that customers send back additional information required by the shipping company and customs. After receiving the information, the cargo company then sends the data to the shipping company or customs by paper, mail, phone, text messages, etc., in order to complete the export-related paperwork. The cargo company then arranges for truck pick-up and delivery via email, phone, text messages, etc.

The above operations not only are inefficient and time-consuming, but also seriously affect the speed of data processing and operation. Furthermore, due to communication and file transfer obstacles between the shipper, the buyer, the cargo company, and the shipping company, the shipper and buyer are unable to keep track of order progress and goods flow.

The present invention intends to provide an operating end export operation system for logistics to eliminate the shortcomings mentioned above.

### SUMMARY OF THE INVENTION

The main purpose of this invention is to provide end-to-end communication connections for export operations through wireless network for the client end communication tool, the shipping company booking system, and the shipping end communication tool. This enables the generation of multiple orders containing product information, completion of booking based on product information in the shipping company booking system to generate booking information, and output of a truck pickup dispatch order based on the booking information. At the same time, it provides the client end communication tool and shipping end communication tool to query the progress of each order, thus realizing the full visualization of online service for ordering, booking, and truck dispatch.

The present invention relates to an operating end export operation system for logistics comprising:
an order module 11, a booking operation module 12, a transmission module 13, a processing module 14, a display module 15, and a recording module 16, the order module 11, the booking operation module 12, the transmission module 13, the processing module 14, the display module 15, and the recording module 16 being linked with each other, the operating end export operation system 10 communicating with a client end communication tool 20, a shipping company booking system 30 and a shipping end communication tool 40, the order module 11 containing built-in multiple orders 111 with product information 1111, the booking operation module 12 receiving the multiple orders 111 and transmitting the product information 1111 of each order 111 to the shipping company booking system 30 for booking, after completing the booking, the shipping company booking system 30 transmits a booking information 31 containing a customs requirement 311 to the transmission module 13, the transmission module 13 transmits the booking information 31 to the processing module 14, the recording module 16 and the shipping end communication tool 40, the processing module 14 receives the booking information 31 and sends a dispatch order 151 for pickup to the display module 15, the recording module 16 records the product information 1111, the booking information 31, the customs requirement 3111, and a dispatch order 151 of each order.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is the block diagram of the operating end export operation system of the present invention;

FIG. 2 is another block diagram of the operating end export operation system of the present invention, and

FIG. 3 is a block diagram of a preferred embodiment of the operating end export operation system of the present invention.

### DETAILED DESCRIPTION OF THE PREFERRED EMBODIMENT

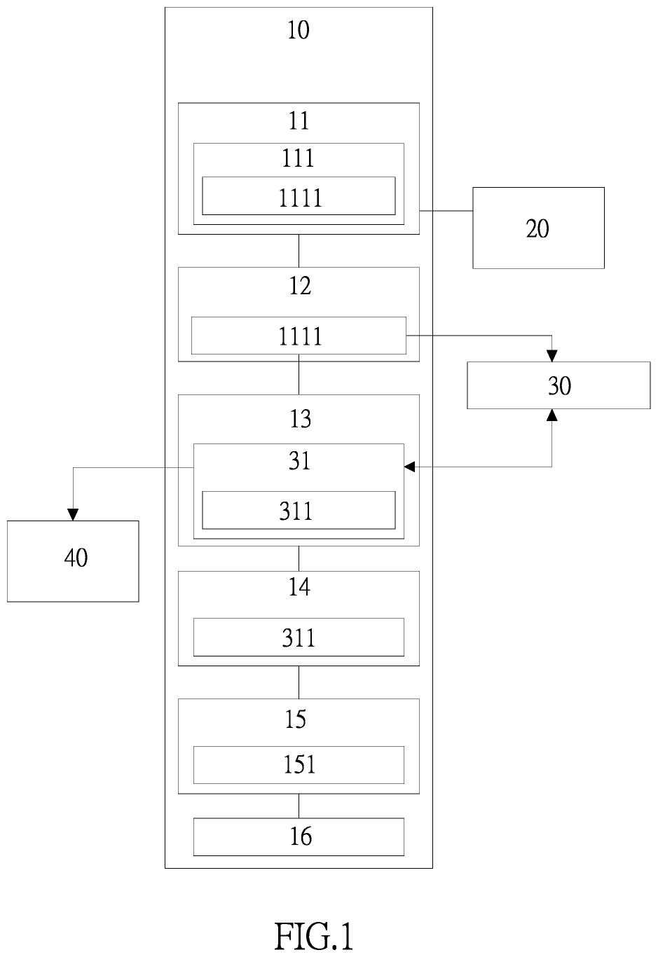

Referring to FIGS. 1 to 3, the operating end export operation system 10 for logistics of the present invention comprises an order module 11, a booking operation module 12, a transmission module 13, a processing module 14, a display module 15, and a recording module 16. The order module 11, the booking operation module 12, the transmission module 13, the processing module 14, the display module 15, and the recording module 16 are communication linked with each other. The operating end export operation system 10 communicates with a client end communication tool 20, a shipping company booking system 30 and a shipping end communication tool 40. The order module 11 contains built-in multiple orders 111 with product information 1111 (including product name, weight, volume). The booking operation module 12 receives the multiple orders 111 and transmits the product information 1111 of each order 111 to the shipping company booking system 30 for booking. After completing the booking, the shipping company booking system 30 transmits a booking information 31 containing a customs requirement 311 to the transmission module 13. The transmission module 13 transmits the booking information 31 to the processing module 14, the recording module 16 and the shipping end communication tool 40. The processing module 14 receives the booking information 31 and sends a dispatch order 151 for pickup to the display module 15. The recording module 16 records the product information 1111, the booking information 31, the customs requirement 311, and a dispatch order 151 of each order.

The customs requirement 311 includes shipping, instruction, VGM, CCAM, ISF, etc.

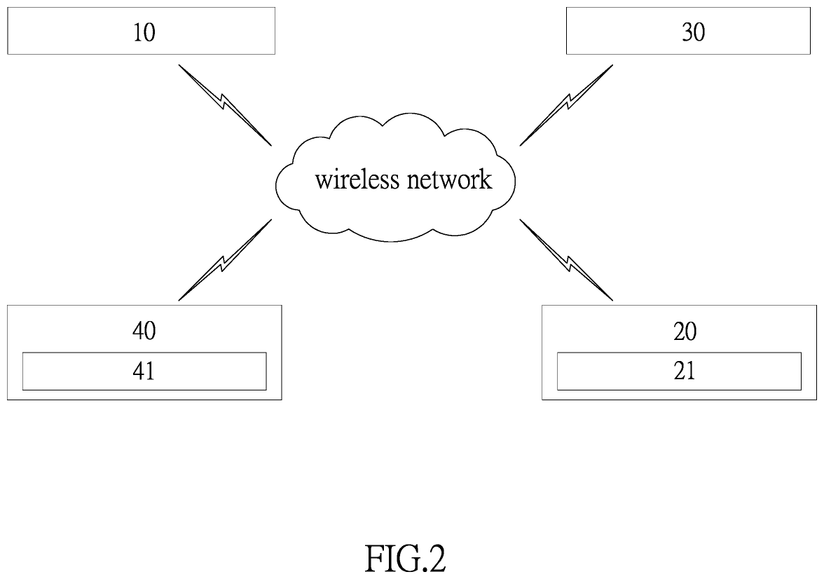

As shown in FIGS. 1 and 2, in practice, the invention provides the client end communication tool 20 with communication connection operation through the order module 11, so as to generate multiple orders 111 containing product information 1111 (including product name, weight, volume). Therefore, the booking operation module 12 transmits the product information 1111 to the shipping company booking system 30. After completing the booking, the transmission module 13 transmits the booking information 31 to the processing module 14, the record module 16, and the shipping end communication tool 40. The processing module 14 receives the booking information 31 and outputs a truck pickup dispatch order 151 in compliance with the customs requirement 311 to the display module 15 which displays the dispatch order 15. The operator of the operating end export operation system 10 is required to follow the regulations of the customs requirement 311 for truck pickup.

In addition, as shown in FIG. 2, since the client end communication tool 20 and the shipping end communication tool 40 each have a display screen 21, 41, thus, the operating end export operation system 10 provides the client end communication tool 20 and the shipping end communication tool 40 with end-to-end export operation communication connection through a wireless network. This allows access to the record module 16 to inquire about the processing progress of each order 111, and to view the order progress and product flow data through the display screens 21, 41. Therefore, the present enables the operator of the operating end export operation system 10 to realize the whole process visualization online service of ordering, booking, and truck dispatch.

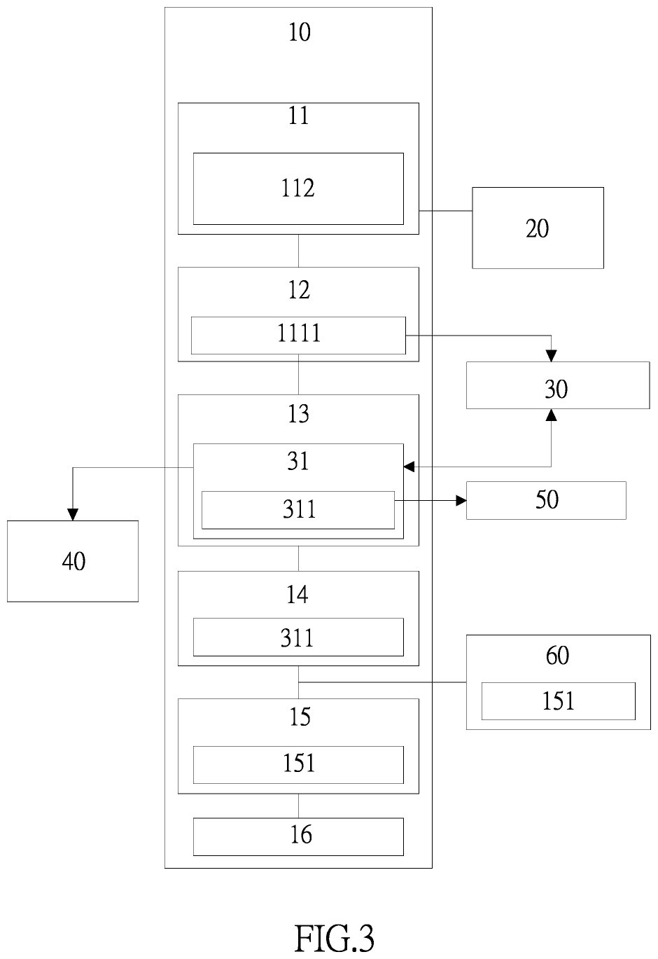

As shown in FIG. 3, the operating end export operation system 10 includes a fleet dispatch system 60 that communicates with the processing module 14, and the processing module 14 sends the dispatch order 151 to the fleet dispatch system 60. The dispatch order 151 instructs the drivers of the fleet dispatch system 60 to pick up the product according to the customs requirement 311.

As shown in FIG. 3, the order module 11 includes a built-in receipt attachment section 112. The receiving attachment section 112 provides the client end communication tool 20 to receive electronic invoices and recharge through wireless network communication.

In this embodiment, as shown in FIG. 3, the transmission module 13 communicates with the customs 50. After the transmission module 13 receives the booking information 31, the transmission module 13 transmits the customs requirement 311 to the shipping company booking system 30 and the customs 50. The customs requirement 311 may also sent by paper, mail, telephone, SMS, etc.

While we have shown and described the embodiment in accordance with the present invention, it should be clear to those skilled in the art that further embodiments may be made without departing from the scope of the present invention.

What is claimed is:

1. An operating end export operation system for logistics comprising:
an order module, a booking operation module, a transmission module, a processing module, a display module, and a recording module, the order module, the booking operation module, the transmission module, the processing module, the display module, and the recording module being communication linked with each other, the operating end export operation system communicating with a client end communication tool, a shipping company booking system and a shipping end communication tool, the order module containing built-in multiple orders with product information, the booking operation module receiving the multiple orders and transmitting the product information of each order to the shipping company booking system for booking, after completing the booking, the shipping company booking system transmits a booking information containing a customs requirement to the transmission module, the transmission module transmits the booking information to the processing module, the recording module and the shipping end communication tool, the processing module receives the booking information and sends a dispatch order for pickup to the display module, the recording module records the product information, the booking information, the customs requirement, and a dispatch order of each order.

2. The operating end export operation system for logistics as claimed in claim 1, wherein the operating end export operation system includes a fleet dispatch system that communicates with the processing module, the processing module sends the dispatch order to the fleet dispatch system.

3. The operating end export operation system for logistics as claimed in claim 1, wherein the order module includes a built-in receipt attachment section.

4. The operating end export operation system for logistics as claimed in claim 1, wherein the transmission module communicates with a customs, after the transmission module receives the booking information, the transmission module transmits the customs requirement to the shipping company booking system and the customs.
